(19) United States
(12) Patent Application Publication
(10) Pub. No.: US 2006/0032678 A1
(43) Pub. Date: Feb. 16, 2006

(54) Apparatus for counting articles by weight

(76) Inventors: Duncan M Johnson, Worcestershire (GB); David Little, Derbyshire (GB)

Correspondence Address: Clifford Kraft, 320 Robin Hill Dr, Naperville, IL, 60540, US

(21) Appl. No.: 10/513,984

(22) PCT Filed: May 14, 2003
(86) PCT No.: PCT/GB03/02071

§ 371 Date: Nov. 8, 2004

(30) Foreign Application Priority Data
May 14, 2002 (GB) 0210945.2

(51) Int. Cl. G01G 19/22; G01G 19/34

(52) U.S. Cl. 177/25.13

(57) ABSTRACT

Articles such as bank notes or coins are counted by weighing them on a weighing machine (100). The weighing machine does not itself have the capability to compute the number of items by dividing the total weight by a nominal weight. Instead this and related functions are carried out by an independent computer (105) which has been programmed with dedicated software. This enables the weighing machine (100) per se to be cheaper and simpler and the combined apparatus has numerous advantages including greater versatility.

This invention relates to apparatus for counting articles by weight, particularly, but not exclusively, currency in the form of bank notes or coins.

It is well known to count bank notes or coins by weighing them. GB-A-2115163 discloses apparatus for the purpose and GB-A-2076979 and GB-A-2218218 disclose techniques employed for the purpose. Notes or coins to be weighed together must all be of the same kind, e.g. £1 coins, £5 notes. This normally presents no difficulty because as money is taken, e.g. in a retail outlet, it is sorted into different compartments of a till drawer. Normally the compartments are fitted with removable till cups in which the contents of a compartment can be transferred bodily to the hopper of a weighing machine. The weight of the container is “known” by the machine and subtracted from the total weight. The remaining weight is then divided by the average weight of notes or coins of the denomination concerned, this average weight being also “known” by the machine. In a sophistication of the technique known as “histogram counting” an item tolerance is used to work out a range of weights that represent unambiguous counts. If an unambiguous count is recognised this is used to adjust the average weight, and the adjusted weight is used in subsequent counts.

Weighing machines hitherto used for counting coins and bank notes have been stand-alone machines incorporating all the components necessary for weighing the items, for storing an average weight value for the particular items being weighed and for converting the weight value into a number which is then displayed by the machine. Thus such machines have incorporated inter alia a microprocessor capable of storing the data, carrying out the calculations and displaying the results. The cost of such machines is of course a reflection of their complexity.

A principal object of the present invention is to reduce the cost of the provision of the apparatus while at the same time improving its performance and versatility. This is achieved by removing from the weighing machine itself the majority of the computational and display functions and entrusting them instead to an independent computer. Thus a weigh/counting machine in accordance with the present invention ceases to be a stand-alone item and becomes a peripheral, i.e. it must have a symbiotic relationship with a computer.

Computers are now every day items and are found in numbers in most offices. A typical computer has many times the memory and the computational power of the microprocessors hitherto used in weigh/counting machines, such that to take over the functions of such a microprocessor will not impair other functions of the computer. This not only allows the weigh/counting machine itself to be sold more cheaply, but taking advantage of the greater computing power of the independent computer a more powerful and more versatile counting to tool is made available. Customers for the new weigh/counting machines can be assumed already to possess computers so that their only additional requirement will be to install on them appropriate, dedicated software.

In accordance with the present invention there is provided apparatus for counting articles by weight comprising, in combination, a weighing machine adapted to provide electronic output signals proportional to a number of articles of similar weight placed on the weighing machine, means for establishing a connection between the weighing machine and a computer independent of the weighing machine and a computer program adapted to program said computer inter alia to receive and to interpret the said output signals and to display a value corresponding with the number of articles placed on the weighing machine, the apparatus being characterised in that the weighing machine is a computer peripheral which has no means for converting weight into displayed numerical values.

The program is preferably adapted to program the computer to maintain a dialogue with the weighing machine in which the said output signals are compared with data relating to the average weight of said articles.

The program is preferably adapted to program the computer with average weight data of categories of articles of different average weight and command input means is preferably provided to select the category of articles to be weighed by the weighing machine.

The computational capacity of the weighing machine per se may be limited to a single chip microcontroller.

Said means for establishing a connection may be a cable. Said cable may be connected at one end to the weighing machine and may have at its other end a plug for insertion into a port of the independent computer.

Alternatively said means for establishing a connection may be cordless.

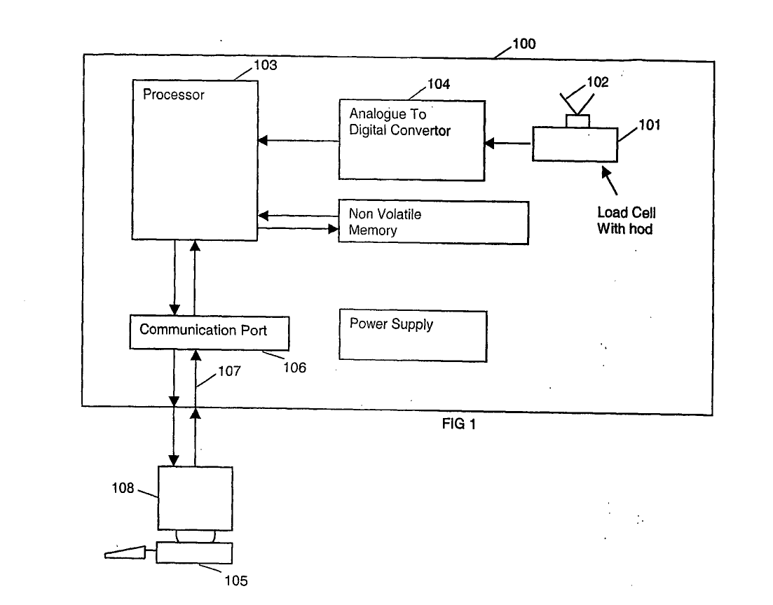

A preferred embodiment of the present invention will now be described by way of non-limitative example with reference to the accompanying drawing, in which FIG. 1 is a block diagram of apparatus in accordance with the present invention.

Referring to FIG. 1, the apparatus comprises a weighing machine 100 having a load cell 101 fitted with a hopper 102 to receive items to be weighed. The load cell is connected to a micro processor 103 of the weighing machine 100 via an analogue to digital converter 104. The micro processor 103 controls the converter 104 to derive a filtered digital value representative of the weight on the hopper 102. Raw data about the items to be counted is provided to the micro processor 103 by an independent personal computer 105 via a communication port 106. Typically this will include the nominal item weight and the percentage tolerance and the weight of any container such as a bag or till cup in which the items to be counted are contained. The micro processor 103 uses this raw data to calculate the count of the items on the hod 102 and returns this information to the computer 105 via the communications port 106 of the weighing machine, which in the example illustrated is connected to the computer by a cable 107.

The calculation can be done in one of two ways; either by allowing for any container weight and dividing the remaining weight by the nominal weight (rounding the answer to the nearest whole count) or by including an item tolerance to work out a range of weights that represent unambiguous counts. If an unambiguous count is recognised this is returned to the computer 105 together with a slightly adjusted version of the nominal weight, which is then used the next time the same items are counted. If an ambiguous count is recognised a signal goes to the computer 105 whereby it displays on its VDU 108 an indication that some or all of the items on the hopper 102 should be removed. The process is repeated with a different weight of the items on the hopper 102 until an unambiguous count is found.

This procedure is known as histogram counting and is known per se. It is used for counting items whose nominal weight varies both inherently and with usage, for example bank notes which have a wide basic weight tolerance which is affected by wear, humidity and dirt build-up.

The computer 105 stores data concerning the nominal weights of a range of items to be counted as well as the weight(s) of any containers for items being weighed. It is programmed to conduct a dialogue with the weighing machine 100.

The following details the protocol of the dedicated software with which the computer 105 has been programmed.

The micro processor 103 of the weighing machine maybe a single chip 8051 type microcontroller with limited RAM. This is taken into account in the program of the computer by limiting the fame lengths, thus allowing relatively small buffers to be used in the weighting machine.

Frame Format

| STX | CMD DATA | ETB/ETX CRC | |
|---|---|---|---|
| STX | Start of frame character | 02h | * |
| CMD | Command character | printable ASCII character | * |
| DATA | Data characters | 1 to 17 ASCII hex characters | * |
| ETB/ETX | End of frame character | 17h/03h | * |
| CRC | Cyclic redundancy check | 4 ASCII hex characters | |

* these characters are used to compute the CRC.

CRC

The CRC is the industry standard CRC-16, given by the polynomial X¹⁶+X¹⁵+X²+X⁰ (8005 h) and will detect the following errors:
All single bit errors
All 2 bit errors
All errors with an odd number of error bits
All burst errors of 16 bits or less
99.97 of all 17 bit errors.

The choice of the CRC is based on the need for a check sequence of more than a single byte and on the availability of a tried and tested polynomial. The initial value of the CRC register is 0000 h and is left shifted as the CRC is calculated. The message is processed MSB to LSB to calculate the CRC.

Message Frames

The following gives the details of the messages defined in the protocol:

Computer to Weighing Machine

The frames all have the format outlined above. The command and data portions of each message type are detailed below.

Count Items

Count items messages contain 3 data elements, each of 4 ASCII hex characters representing unsigned integers. The message length including the CRC is 23 bytes.

| | | | | | |
|---|---|---|---|---|---|
| STX CMD DATA 1 | DATA 2 | DATA 3 | DATA 4 | ETX | CRC |

| | | |
|---|---|---|
| CMD | ASCII | Hex |
| Count in estimation | E | 45 |
| mode | | |
| Count in histogram | H | 48 |
| mode | | |

| | | | |
|---|---|---|---|
| DATA 1 | Item weight (×0.001 g) | unsigned integer | 4 ASCII hex |
| | | | chars |
| DATA 2 | Tolerance (×0.1%) note 1 | unsigned integer | 4 ASCII hex |
| | | | chars |
| DATA 3 | Package weight (×0.01 g) | unsigned integer | 4 ASCII hex |
| | | | chars |
| DATA 4 | Nominal weight (×0.001 g) | unsigned integer | 4 ASCII hex |
| | | | chars |

Separate values may be used for +ve and −ve tolerances. The MS and LS bytes hold the +ve tolerance and −ve tolerance values respectively.

Used in histogram counting—the item weight should be the last learned weight received when the same item was last counted. The nominal weight is the ideal weight for that item and should remain unchanged. The item weight must also lie in the range given by the nominal weight with the +ve and −ve tolerances applied.

Store Items

This command is used to store learned weights and other configuration data in the VLC EEPROM.

Store items messages contain 5 data elements. The total message length is 24 bytes.

| | | | |
|---|---|---|---|
| STX CMD DATA 1 | DATA 2 DATA 3 | DATA 4 DATA 5 | ETB/X CRC |

| | | |
|---|---|---|
| CMD | ASCII | Hex |
| Set learned weight | L | 4C |
| Set package weight | p | 50 |
| Set calibration | C | 43 |
| Set configuration ID | I | 49 |

| | | | |
|---|---|---|---|
| DATA 1 | Item N ID | char | printable ASCII char |
| DATA 2 | value N | unsigned integer | 4 ASCII hex chars |
| DATA 3 | value (N + 1) | unsigned integer | 4 ASCII hex chars |
| DATA 4 | value (N + 2) | unsigned integer | 4 ASCII hex chars |
| DATA 5 | value (N + 3) | unsigned integer | 4 ASCII hex chars |

If there are more items to be stored ETB follows DATA 5; otherwise ETX follows DATA 5 in the last frame containing items to be stored.

When sending learned weight data as a block of frames, all but the last frame should have ETB as the end of frame character. The last frame in a block must have ETX as the end of frame character; otherwise subsequent data frames will overwrite existing data. Unlike other message types the ETX end of frame character does not cause the machine to enter talk mode.

Set learned weight frames can be alternated with set pack weight frames. The frame data is appended to the existing EEPROM data until the memory overflows. In the present example 47 stored item frames can be stored in total.

Sending a set config ID message erases stored items and package data from the EEPROM.

Instructions

These are commands to the machine which do not include data. The message length including the CRC is 7 bytes.

| STX CMD | ETB/X | CRC |
|---|---|---|
| CMD | ASCII | Hex |
| Cancel last command (ETB) | u | 75 |
| Get weight in grams (ETX) | g | 67 |
| Get raw count (ETX) | c | 63 |
| Get mean raw count (ETX) | m | 60 |
| Reset weighing machine | r | 72 |
| Get learned weights (ETX) | l | 6C |
| Get package weights (ETX) | p | 70 |
| Get calibration | a | 61 |
| Get configuration ID (ETX) | o | 6F |
| Get status (ETX) | s | 73 |
| Set ADC zero (ETB) | z | 7A |

Acknowledgements

Acknowledgements are single characters sent by a receiver when a valid message has been processed. Acknowledgements do not have the standard frame format. Instead a single character is sent twice in succession giving a message length of 2 bytes. By sending the codes twice the probability of a random error producing a different valid code is 1 in 65536 (1 in 256 with a single character). The acknowledgement is only recognised if both codes are identically received. This is to minimise the occurrence of deadlocks should a NAK be corrupted in transmission to an ACK.

| | ACK 1 (NAK 1) | ACK 2 (NAK 2) |
|---|---|---|
| Acknowledgement | ASCII | Hex |
| Positive acknowledge (Ack) | ACK | 06 |
| Negative acknowledge (Nak) | NAK | 15 |

In what follows Ack and Nak refer to 2 ACKs (NAKs) in succession.

Weighing Machine to Computer

The frames all have the format outlined above. The command and data portions of each message type are detailed below.

Item Weight or Count

Sent by the weighing machine in response to a count items (‘E’ or ‘H’), get weight in grams (‘g’) or get raw count (‘c’) command from the PC.

Items weight or count messages contain 2 data elements, each of 4 ASCII hex characters representing unsigned integers. The message length including the CRC is 15 bytes.

| STX | CMD DATA 1 | DATA 2 ETB | CRC |
|---|---|---|---|
| CMD | echoes the command from the host that originated the | | |
| | message e.g. ‘H’ | | |
| DATA 1 | Item weight or | unsigned integer* | 4 ASCII hex chars |
| | count | | |
| DATA 2 | Learned weight | unsigned integer | 4 ASCII hex chars |

DATA 1 represents a weight or count depending on CMD.
DATA 2 is the new learned weight calculated by the weighing machine when CMD is count in histogram (‘H’) and is 0000h otherwise.
*Grams weight raw count and mean count are signed integers.

Power-Up

On power up or on receipt of a reset command (‘r’) from the computer the weighing machine initiates a reset and enters listen mode. The computer powers up in talk mode.

Weighing Machine Response to Computer Messages

The weighing machine Acks if the computer is in listen mode, the message is valid and the weighing machine is ready to process it, and then either stays in listen mode or prepares to enter talk mode as described above. After a time t₄ or on receipt of an Ack from the computer the weighing machine enters talk mode.

If the weighing machine is in listen mode and the message is invalid the weighing machine replies with Nak and stays in listen mode.

If the weighing machine is in talk mode it replies with a busy processing last command message (‘J’) and remains in talk mode, except when the received message is a cancel command (‘c’).

If the message is a cancel command the weighing machine Acks and enters listen mode. In normal circumstances the weighing machine should never receive a message other than a cancel command when in talk mode. However a corrupted acknowledgement (e.g. Ack changes to Nak) could cause this to occur.

Computer Responses to Weighing Machine Acknowledgements

In the case of an Ack received by the computer in response to a transmitted message the computer prepares to enter talk mode or listen mode depending upon the message just Ack'd. If no Ack is received or if Nak is received the computer re-transmits the sent message a maximum of N times.

If a Nak is received from the last re-transmission or if no Ack has been received the computer assumes a communications failure has occurred. If a busy message (‘j’) is received the computer sends a cancel command (‘c’) instead of re-transmitting the last sent message.

After sending a message the Ack or Nak should be received within time t₁ otherwise a Nak is assumed. Similarly after receiving the first character in a message the last character in the message should be received within time t₂ for the message to be valid.

After receiving an Ack from the weighing machine to the computer command with ETX as the end of frame character, the message following from the weighting machine should be correctly received within time t₃, otherwise a communications failure is assumed. Recovery by the computer from a communications failure is application dependent.

Computer Response to Weighing Machine Messages

The computer Acks if the computer is in listen mode, the message is valid and the computer is ready to process it and then either stays in listen mode or prepares to enter talk mode as described above. After a time T₄ or on receipt of an Ack from the weighing machine the computer enters talk mode.

If the computer is in listen mode and the message is invalid the computer replies with Nak and remains in listen mode.

If the computer is in talk mode the computer replies with a cancel command (‘c’) and remains in talk mode. In normal circumstances the computer should never receive a message when in talk mode. However a corrupted acknowledgement (e.g. Ack changes to Nak) could cause this to occur.

Weighing Machine Responses to Computer Acknowledgements

In the case of an Ack received by the weighing machine in response to a transmitted message the weighing machine prepares to enter talk mode or listen mode depending upon the message just, Ack'd. If no Ack is received or if Nak is received the weighing machine re-transmits the sent message a maximum of N times.

If a Nak is received from the last re-transmission or if no Ack has been received the weighing machine enters listen mode.

After sending a message the Ack or Nak should be received within time t₁ otherwise, a Nak is assumed. Similarly after receiving the first character in a message the last character in the message should be received within time t₂ for the message to be valid.

In the case of an Ack received by the weighing machine in response to an Ack sent by the weighing machine (after receiving an ETX message) the weighing machine enters talk or listen mode as appropriate.

Message Re-Transmission and Time Outs

N 2

| | | |
|---|---|---|
| t₁ | 200 | ms |
| t₂ | 100 | ms |
| t₃ | t₂ + t₄ + 250 | ms |
| t₄ | (N * t₁) + 50 | ms |

The appended Table 1 is illustrative of a typical dialogue between the VLC and host: The system starts in the normal idle state with the computer in control. The computer initiates the dialogue (1) sending a command message (2) to the weighing machine which instructs the weighing machine to go into Count Histogram mode for the items specified in the data included in the command. This data typically includes the item current weight, the weight tolerance, packaging weight and the item nominal weight. This message is received by the weighing machine which will typically produce an Acknowledgement (9) at which point the computer will send a further acknowledgement (11) and pass the initiative to the weighing machine.

The weighing machine may alternatively produce a series of status messages in response to the original command (2)—these include No Acknowledgement (3) and Busy (4). On receipt of these status messages the computer performs a series of recovery procedures to try and reach the correct state. These include use of the Cancel command (5) and repeated attempts of the original command (1).

Once the weighing machine has the initiative (12) the user can add items to the hod 11 and the weighing machine will process the weight changes using the histogram counting algorithm and produce a resulting histogram count (13) that is transmitted to the computer. This message typically contains the item count and a new learned weight for the item. The computer will acknowledge receipt of this message (14). The process then continues (15), (15) (16) as the user adds and removes items until the computer retakes the initiative by sending a cancel command (18).

The apparatus herein described, including a computer programmed with dedicated software, has significant advantages over the “stand alone” weigh/counting machine which is currently in use. The weighing machine protocol used in the present invention uses ASCII only and a cyclic redundancy check (CRC). This is a compromise between good error detection and efficiency. The longer frames are likely to be used most of the time and have the higher efficiency. The short command frames are least efficient but are likely to be used least. Related data is sent in a single frame. Sequential control is addressed by the use of half-duplex transmission and the sequencing control described above.

TABLE 1

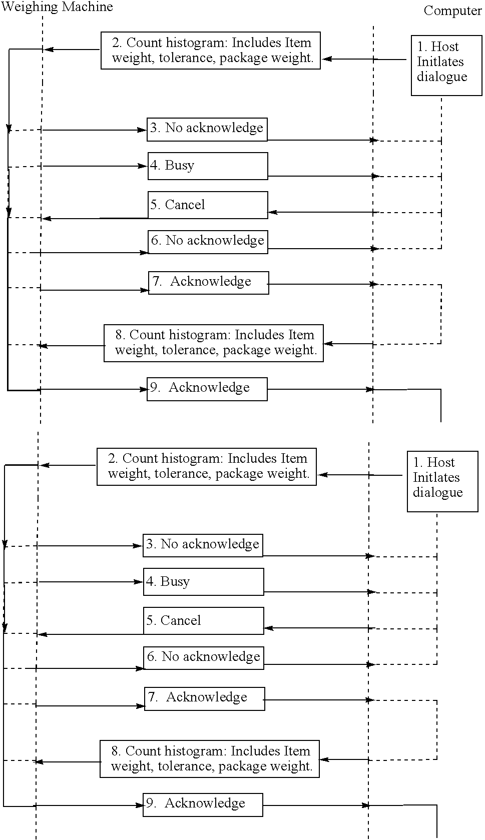

1. Apparatus for counting articles by weight comprising, in combination, a weighing machine (100) adapted to provide electronic output signals proportional to a number of articles of similar weight placed on the weighing machine, means (106) for establishing a connection between the weighing machine (100) and a computer (105) independent of the weighing machine and a computer program adapted to program said computer (105) inter alia to receive and to interpret the said output signals and to display a value corresponding with the number of articles placed on the weighting machine (100) characterized in that the weighing machine (100) is a computer peripheral which has no means for converting weight into displayed numerical values.

2. Apparatus as claimed in claim 1, characterized in that the program is adapted to program the independent computer (105) to maintain a dialogue with the weighing machine (100) in which the said output signals are compared with data relating to the average weight of said articles.

3. Apparatus as claimed in claim 2, characterized in that the program is adapted to program the independent computer (105) with average weight data of categories of articles of different average weight and command input means is provided to select the category of articles to be weighed by the weighing machine (100).

4. Apparatus claimed in claim 1, characterized in that the computational capacity of the weighing machine (100) is limited to a single chip microcontroller (103).

5. Apparatus claimed in claim 1, characterized in that said means for establishing a connection comprises a cable (107).

6. Apparatus as claimed in claim 5, characterized in that said cable (107) is connected at one end to the weighing machine (100) and has at its other end a plug for insertion into a port of an independent computer (105).

7. Apparatus as claimed in claim 1, characterized in that said means for establishing a connection is cordless.
